(19) United States
(12) Patent Application Publication
(10) Pub. No.: US 2005/0225612 A1
(43) Pub. Date: Oct. 13, 2005

(54) Ink refill device of an ink cartridge

(76) Inventors: Yong-Soo Lee, Seoul (KR); So-Yeon Lee, Seoul (KR)

Correspondence Address: RATNERPRESTIA, P O BOX 980, VALLEY FORGE, PA, 19482-0980, US

(21) Appl. No.: 10/508,037

(22) PCT Filed: Mar. 6, 2003
(86) PCT No.: PCT/KR03/00433

§ 371 Date: May 2, 2005

(30) Foreign Application Priority Data
Mar. 18, 2002 (KR) 20-2002-0007905

(51) Int. Cl. B41J 2/175

(52) U.S. Cl. 347/86

(57) ABSTRACT

Disclosed is an ink refill device. In the ink refill device, the main body is provided with a receiving space for receiving an ink cartridge therein, and first ink injecting part through which ink passes is provided on one outer side wall thereof. An ink injector is provided with second ink injecting part corresponding to the first ink injecting part so that ink is injected into the ink cartridge. Further, an ink absorber is provided in the main body neighboring the first ink injecting part to be closely contacted to an ink nozzle so that it absorbs ink being leaked from the ink nozzle. Whereby, a user, the surroundings or the ink cartridge can be prevented from being soiled.

### TECHNICAL FIELD

The present invention relates to an ink refill device of an ink cartridge, and more particularly to an ink refill device of an ink cartridge enabling to protect a user and an ink cartridge from being soiled by ink by screw coupling an ink injector and a main body of the device and by providing airtight sustaining rings and ink absorbing members in a predetermined position in the main body.

### BACKGROUND ART

Recently, computers have been widely supplied to offices as well as to homes, thereby the use of computers has already become a daily activity. Further, many types of printers generally used as a means for outputting work of a computer have been developed. Among these types of printers, especially, ink-jet printers are generally used at home.

However, an ink cartridge required as an expendable supply for the ink-jet printer is relatively expensive compared with the ink-jet printer, therefore it is a considerable financial burden to purchase a new ink cartridge whenever ink is used up.

To solve this problem, various methods and devices for refilling ink in an ink cartridge and for using it again have been actively studied.

In FIG. 6, the ink refill device of an ink cartridge in prior art is schematically shown.

The ink refill device shown in FIG. 6 is disclosed in Korean Utility Model Application No. 00-20350 dated Sep. 29, 2000, and is disclosed in PCT international application PCT/KR01/01042 dated Jun. 19, 2001 of the present applicant. The ink refill device in FIG. 6 consists of the refill holder 20 for receiving the ink cartridge 101 and the syringe 50 for injecting ink into the ink cartridge 101.

The coupling portion 30 is provided on one side wall 22 of the refill holder 10, and the receiving protrusion 53 is provided on the syringe 50. The syringe 50 and the refill holder 10 are coupled to each other by coupling the receiving protrusion 53 and the coupling portion 30.

The ink path 34 is formed in the coupling portion 30, thereby the ink to be supplied by the syringe 50 is supplied into the injecting hole 102 of the ink cartridge 101. The ink in the syringe 50 is supplied into the ink cartridge 101. Afterwards, the piston 54 is gradually and repeatedly pulled and pushed so that the inner pressure of the ink cartridge 101 is controlled. Whereby, the ink is not discharged to the outside of the ink cartridge 101 through the injecting hole 102 even if the ink cartridge 101 is separated from the refill holder 20.

The ink cartridge 101 in which the inner pressure has been controlled is inserted into the discharge holder 70 in FIG. 7 again, and small amount of ink is discharged through the ink nozzle 103. Whereby, it prevents the ink nozzle 103 of the ink cartridge 101 to be blocked due to dried-up ink, and the ink cartridge 101 is under a state in which it can be used as soon as being mounted on a printer.

However, in this prior ink refill device, the refill holder for receiving the ink cartridge is opened. Therefore, if the ink cartridge is broken due to a sudden increase of the inner pressure while ink is being refilled, there is a problem in that a user and the surroundings are soiled.

Further, there is another problem in that the user and the ink cartridge are soiled, since the leaked ink from the nozzle of the ink cartridge can not be perfectly absorbed due to a thin ink absorber.

Further, there is still another problem in that ink is leaked from the coupling portion between the ink syringe and the ink injecting hole, since they did not have perfect airtightness.

### DISCLOSURE OF INVENTION

Therefore, the present invention has been developed to solve the above-mentioned problems. It is an object of the present invention to provide an ink refill device of an ink cartridge enabling to safely refill ink in the ink cartridge without soiling a user, the surroundings or the ink cartridge.

To achieve the above object of the present invention, the present invention provides an ink refill device including an ink cartridge body having an ink injecting hole and an ink nozzle, and an ink cartridge cover having an air injecting hole. The ink refill device comprises a main body having a receiving space for receiving the ink cartridge therein, and having first ink injecting part in which an ink path through which ink passes is formed on one outer side thereof; an ink injector provided with second ink injecting part coupled with the first ink injecting part so that ink is injected into the ink cartridge; and an ink absorbing member provided in the main body at near the first ink injecting part to be closely contacted to the ink nozzle so that it prevents ink from being leaked from the ink nozzle while ink is being refilled.

The ink refill device further includes a detachable cover to cover a receiving space, which is an opened-side of the main body. Whereby, the worker and the surroundings are prevented from being soiled even if the ink cartridge is broken while ink is being refilled.

Further, an elastic member is provided in the main body at a predetermined position to be opposite of the first ink injecting portion, thereby the ink cartridge can be easily put in and taken out from the main body of the ink refill device.

Further, a first airtight sustaining ring having a larger diameter than that of the ink path is provided on the inner wall of the main body provided with the first ink injecting part, or a second airtight sustaining ring is provided to be closely contacted to the free end of the first ink injecting part. Therefore, ink is prevented from being leaked between the first ink injecting part and the ink injecting hole or between the first ink injecting part and the second ink injecting part while ink is being refilled. Whereby a user or the ink cartridge can be prevented from being soiled.

Further, an ink absorber is formed with a plurality of layers, and more than one layers are formed to have a recess corresponding to the end portion of the ink cartridge. Whereby, the ink leaked from the ink nozzle of the ink cartridge can be perfectly absorbed, and also the ink cartridge can be prevented from being soiled.

The first ink injecting part of the present invention has a hollow cylindrical body formed with first threads on the outer periphery surface thereof, and the second ink injecting part has an outer body formed with second threads corresponding to the first threads on the inner periphery surface thereof and has an inner body to be inserted into the first ink injecting part. Or, the first ink injecting part has a hollow cylindrical body formed with first threads on inner periphery surface thereof, and the second ink injecting part has a hollow cylindrical body formed with second threads corresponding to the first threads on the outer periphery surface thereof. Whereby, the first ink injecting part and the second injecting part can be reliably coupled to each other.

### BRIEF DESCRIPTION OF DRAWINGS

Other features and advantages of the present invention will become more apparent from the following description taken in connection with the accompanying drawings, wherein:

FIG. 1 is a constitutive view of the ink refill device according to the first preferred embodiment of the present invention;

FIG. 2 is a side sectional view of the ink refill device in FIG. 1;

FIG. 2a is an enlarged view of “A” in FIG. 2;

FIG. 3 is a side sectional view showing a state in which the ink cartridge is refilled with ink using the ink refill device in FIG. 1;

FIG. 4 is a side sectional view showing a state in which the inner pressure of the ink cartridge refilled with ink is controlled using the ink refill device in FIG. 1;

FIG. 5 is a partial side view of the ink refill device according to the second preferred embodiment of the present invention;

FIG. 6 is a broken perspective view of the prior ink refill device; and

FIG. 7 is a broken perspective view of the prior ink discharge device.

### BEST MODE FOR CARRYING OUT THE INVENTION EMBODIMENTS

Hereinafter, the ink refill device according to the preferred embodiments of the present invention will be described in detail with reference to the accompanying drawings.

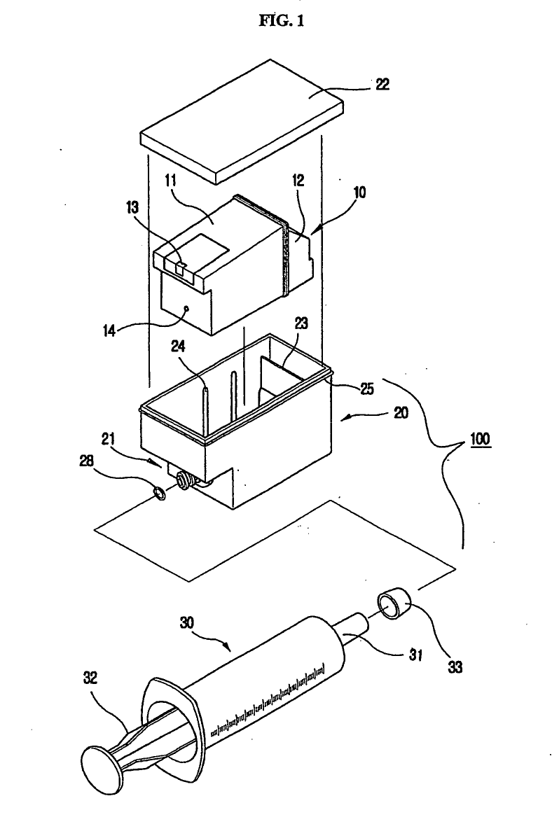

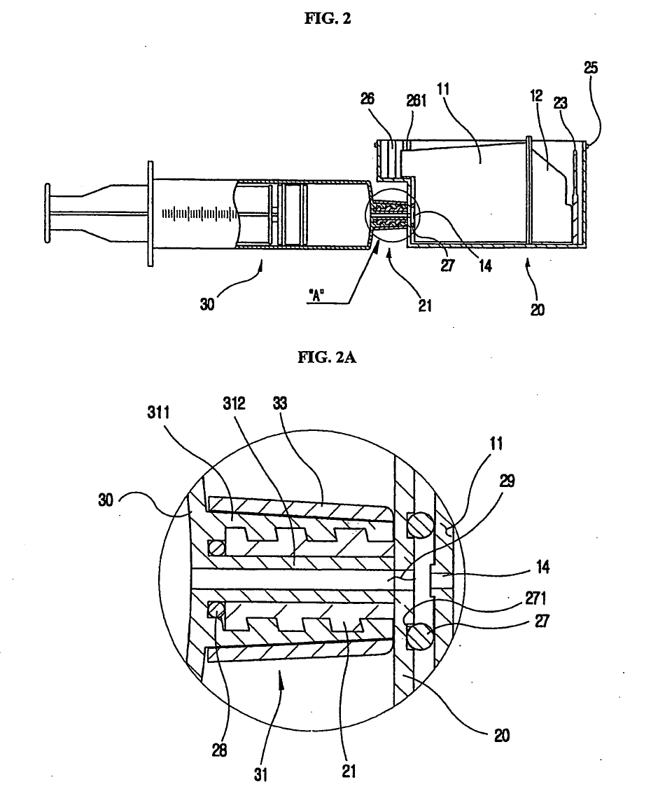

As shown in FIGS. 1 and 2, the ink refill device 100 of the ink cartridge 10 according to the first preferred embodiment of the present invention consists of the main body 20 for receiving the ink cartridge 10 and the ink injector 30. And, preferably, the cover 22 is provided to be detachable from the main body 20.

One outer side wall of the main body 10 is to be stepped, and the center portion of the lower portion of the side wall is provided with first ink injecting part 21 through which ink flows. The first ink injecting part 21 has a hollow cylindrical shape, and first threads are formed on the outer periphery surf ace thereof. Further, the first ink injecting part 21 is preferably formed to protrude longer than the stepped-portion of the main body 20. With this structure, the thickness of the ink absorber 26 provided in the stepped-portion can be increased.

The protrusion 25 is preferably formed to surround all edges of the open side of the main body 20, and a thin recess (not shown) corresponding to the protrusion 25 is formed following all inner edges of the cover 22. With this structure, the cover 22 can be reliably coupled to the main body 20, and the success or failure of their coupling can be easily confirmed.

The main body 20 and the cover 22 are preferably made of transparent plastic materials so that the inside of the main body 20 can be easily seen by the naked eye. And also, the main body 20 and the cover 22 are preferably made of hard materials and soft materials respectively. With this structure, the cover 22 can be easily detached from the main body. Further, it can be easily seen whether the ink cartridge 10 is damaged while ink is being refilled.

A receiving space having a shape corresponding to the outer shape of the ink cartridge 10 is formed in the main body 20.

The ink absorber 26 is provided in the stepped-portion of the inner side wall of main body 20. The ink absorber 26 has a plurality of layers. And, more than one layers which are to be closely contacted to the ink nozzle 13 are formed with second recess 261, and the end portion of the ink cartridge 10 provided with the ink nozzle 13 is inserted into the second recess 261. With this structure, while ink is being refilled, the ink leaked from the ink nozzle 13 can be much more reliably absorbed. A sponge is used as the ink absorber 26 in the present embodiment, however, any materials having an proper absorptivity can be used without limit.

Also, the donut typed first recess 271 having a diameter enabling to sufficiently surround the ink path 29 is formed on the lower portion of the stepped-portion, that is, the inner wall of the main body 20 at the position where the first ink injecting portion 21 is formed. And, the first airtight sustaining ring 27 is fixedly inserted into the first recess 271. With this structure, when the ink cartridge 10 is inserted into the main body 20, the ink injecting hole 14 formed on the ink cartridge 10 is connected to the ink path 29, and an airtightness is sustained between them by the first airtight sustaining ring 27. Further, if the first airtight sustaining ring 27 is damaged due to long time use, it can be easily replaced with a new one.

The elastic member 23, preferably a plate type elastic member 23 is installed near the other inner side wall being opposite to the one inner side wall. Whereby, when the ink cartridge 10 is inserted into the main body 20, the elastic member 23 presses the cover 12 of the ink cartridge 10. Therefore, the ink nozzle 13 and the ink injecting hole 14 can be closely contacted to the ink absorber 26 and to the first airtight sustaining ring 27 respectively. The height of the elastic member 23 is preferably to be bent backward by the worker's fingers in a state in which the ink cartridge 10 is inserted into the main body 20. Whereby, the worker holds the ink cartridge 10 with one hand, and a user can easily take it out from the main body 20 by bending the free end of the elastic member 23 with the other hand.

The fixing members 24 are installed on two inner side walls of the main body 20 but not on the above described inner side walls, and they firmly hold the ink cartridge 10. With this structure, the ink cartridge 10 can be reliably fixed even if an outer force is applied to the ink cartridge 10.

The ink injector 30 is a syringe type. The second ink injecting portion 31 to be coupled to the first ink injecting portion 21 is formed on the front portion of the ink injector 30.

The second ink injecting part 31 according to the first preferred embodiment of the present invention consists of the outer body 311 formed with second threads corresponding to the first threads of the first ink injecting part 21 on the inner periphery surface thereof, and consists of the inner body 312 to be inserted into the first ink injecting part 21. The second airtight sustaining ring 28 is inserted into the coupling portion between the outer body 311 and the inner body 312. Whereby, the first ink injecting part 21 and the second injecting part 31 are screw coupled, therefore they are coupled strongly to each other. Further, since the second airtight sustaining ring 28 is closely contacted to the free end of the first ink injecting part 21, even small amount of ink can be prevented from being leaked between the coupled portion while ink is being refilled.

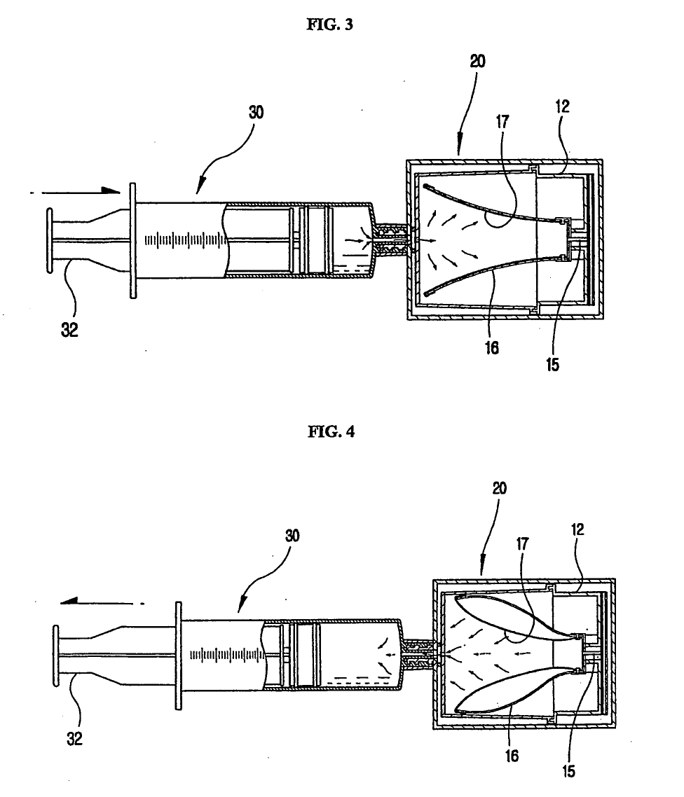

It will be explained by referring to FIG. 3 the process of refilling ink in the ink cartridge 10 using the ink refill device 100 having above described structure.

As shown in FIG. 3, the ink injector 30 is rotated by hands, and then the second ink injecting part 31 is screw coupled to the first ink injecting part 21 provided on the main body 20. At this time, if the free end of the first ink injecting part 21 is strongly and closely contacted to the second airtight sustaining ring 28 installed in the second ink injecting part 31, the user can hear a clicking sound. Therefore, a user can easily confirm whether the coupling has been perfectly accomplished.

Next, a user pushes gradually the piston 32, thereby the ink in the ink injector 30 is injected into the ink cartridge 10. At this time, the air sac 16, provided in the ink cartridge, on which an aluminum thin plate 17 is attached, is pressed and flatted by the ink. That is, the air in the air sac 16 is discharged through the air injecting hole 15 formed on the cover 12 of the ink cartridge 10.

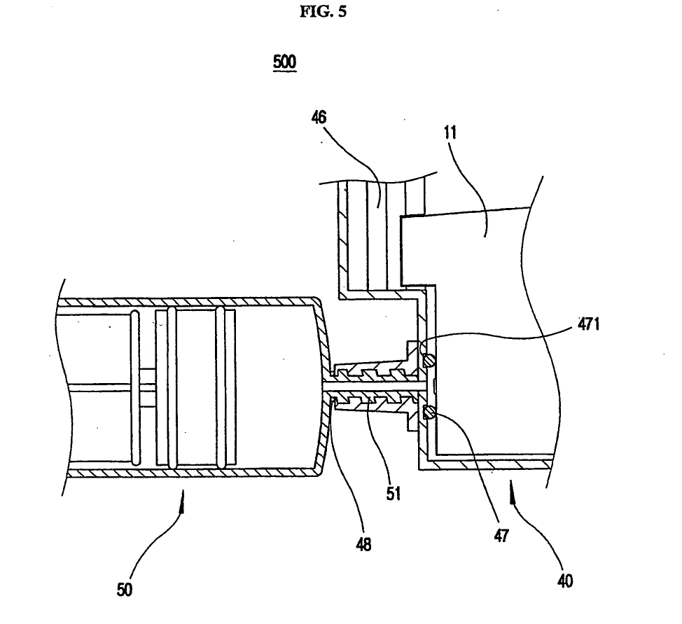

The process to control the inner pressure of the ink cartridge 10 completely refilled with ink will be explained by referring to FIG. 4.

As shown in FIG. 4, if he/she gradually pulls the piston 32, an air is flown into the air sac 16 through the air injecting hole 15, and thereby the inner pressure of the ink cartridge 10 is controlled. At this time, the amount of ink to be discharged by the ink injector 30 is preferably 2˜10 cc as like in the prior art, and much more preferably 2 cc.

To use the ink cartridge 10 which is completely refilled with ink and to control the inner pressure thereof at the optimum state as soon as it is mounted in a printer, preferably about 2 cc of ink should be discharged through the ink nozzle 13. Since this technique is the same as that of the prior art in FIG. 7, it will not be explained.

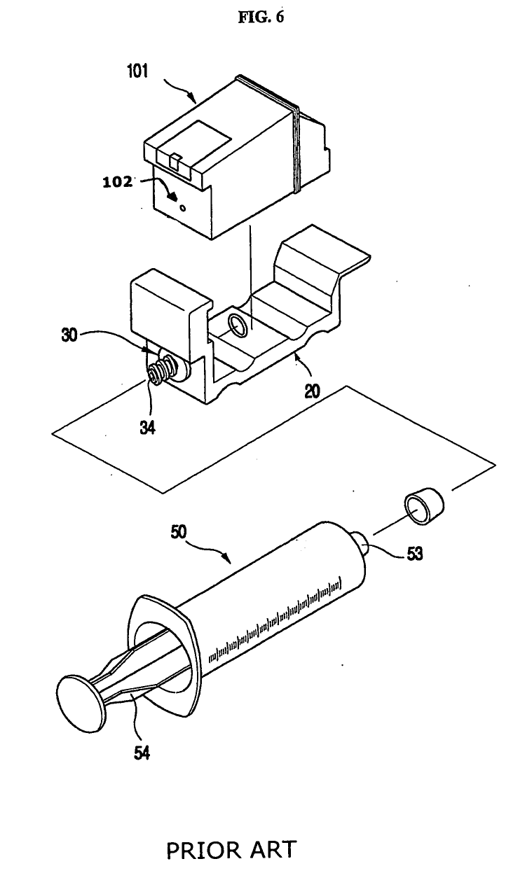

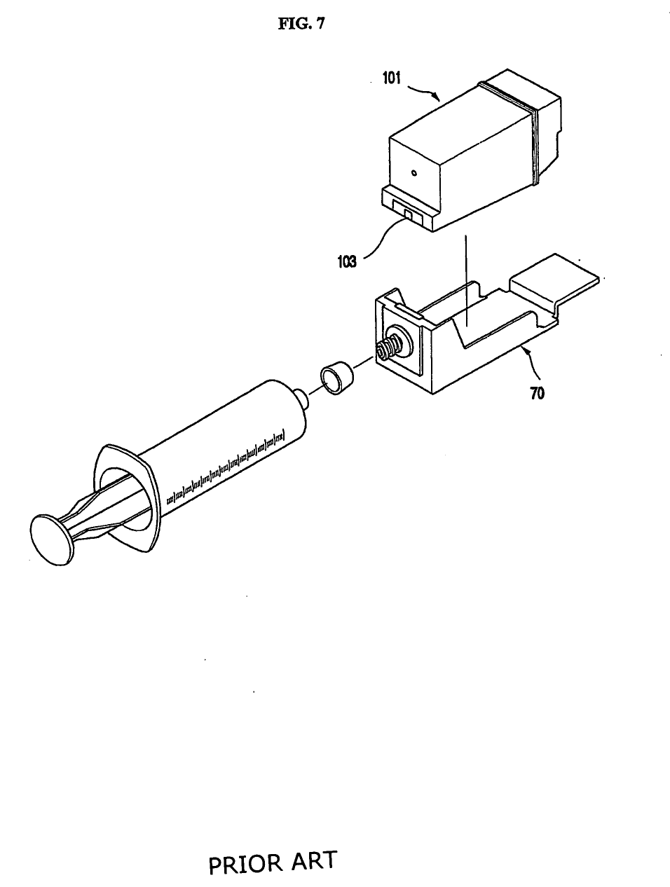

As to the first ink injecting part 21 and the second ink injecting part 31 according to the first embodiment described above, various different embodiments are possible, and the second preferred embodiment is shown in FIG. 5.

As shown in FIG. 5, the first ink injecting part 41 according to the second preferred embodiment of the present invention has a hollow cylindrical body, and first threads are formed on the inner periphery surface thereof. Also, the second ink injecting part 51 has a hollow cylindrical body, and second threads corresponding to the first threads are formed on the outer periphery surface thereof. The second ink injecting part 51 is screwed into the first ink injecting part 41.

In the ink refill device 500 according to the second preferred embodiment described above, the second airtight sustaining ring 48 is closely contacted to the outer periphery of the second ink injecting part 51, therefore the free end of the first ink injecting part 41 is closely contacted to the second airtight sustaining ring 48 when the first ink injecting part 41 and the second ink injecting part 51 are coupled. Whereby, it prevents ink from being leaked between the first ink injecting part 41 and the second ink injecting part 51, thereby it can prevent a user and the surroundings from being soiled.

Other structures and operations are the same as those of the first embodiment of the present invention.

According to the ink refill device of the ink cartridge of the present invention, even if the ink cartridge is broken by a sudden increase of the inner pressure of the ink cartridge while ink is being refilled, a user and the surroundings can be prevented from being soiled.

Further, the ink refill device is provided with a plurality of airtight sustaining rings, thereby it can prevent ink from being leaked to outside while ink is being refilled. Therefore, a user and the ink cartridge can be prevented from being soiled.

Further, the ink discharged through the ink nozzle is perfectly absorbed by the ink absorber, thereby it can prevent the ink cartridge from being soiled.

While the present invention has been particularly shown and described with reference to particular embodiments thereof, it will be understood by those skilled in the art that various changes in form and details may be effected therein without departing from the spirit and scope of the invention as defined by the appended claims.

1. An ink refill device including an ink cartridge body having an ink injecting hole and an ink nozzle, and an ink cartridge cover having an air injecting hole, the device comprising:
a main body having a receiving space for receiving said ink cartridge therein, and having first ink injecting part in which an ink path through which ink passes is formed on one outer side thereof;
an ink injector provided with second ink injecting part to be coupled with said first ink injecting part so that ink is injected into said ink cartridge;
an ink absorber provided in said main body neighboring said first ink injecting part to be closely contacted to said ink nozzle so that it prevents ink from being leaked from said ink nozzle while ink is being refilled.

2. The ink refill device as claimed in claim 1, wherein said device further comprises a detachable cover to cover said main body.

3. The ink refill device as claimed in claim 1, wherein a predetermined elastic member is provided in said main body to be opposite to said first ink injecting part so that said ink cartridge is easily put in and taken out.

4. The ink refill device as claimed in claim 1, wherein a donut type first airtight ring having a larger diameter than that of said ink path is formed on the inner wall of said main body provided with said first ink injecting part so that it prevents ink from being leaked between said first ink injecting part and said ink injecting hole of said ink cartridge while ink is being refilled.

5. The ink refill device as claimed in claim 4, wherein second airtight sustaining ring is provided to be closely contacted to the free end of said first ink injecting part so that it prevents ink from being leaked between said first ink injecting part and said second ink injecting part while ink is being refilled.

6. The ink refill device as claimed in claim 1, wherein more than one fixing members are provided in said main body so that said ink cartridge is fixedly received.

7. The ink refill device as claimed in claim 1, wherein said ink absorber consists of a plurality of layers, and more than one layers thereof have a recess corresponding to the end portion of said cartridge body.

8. The ink refill device as claimed in claim 1, wherein said first ink injecting part has a hollow cylindrical body formed with first threads on the outer periphery surface thereof, and wherein said second ink injecting part has an outer body formed with second threads corresponding to said first threads on the inner periphery surface thereof and an inner body inserted into said first ink injecting part, thereby said first ink injecting part and said second ink injecting part are screw coupled to be closely contacted to each other.

9. The ink refill device as claimed in claim 1, wherein said first ink injecting part has a hollow cylindrical body formed with first threads on the inner periphery surface, and said second ink injecting part has a hollow cylindrical body formed with second threads corresponding to said first threads, thereby said first ink injecting part and said second ink injecting part are screw coupled to be closely contacted to each other.
